(19) United States
(12) Patent Application Publication
(10) Pub. No.: US 2013/0271949 A1
(43) Pub. Date: Oct. 17, 2013

(54) LIGHT GUIDE STRUCTURE FOR A PHONE KEY

(71) Applicant: XIAMEN SONGYAO OPTICS CO., LTD., Xiamen (CN)

(72) Inventor: Chongsheng ZHAO, Xiamen (CN)

(73) Assignee: XIAMEN SONGYAO OPTICS CO., LTD., Xiamen (CN)

(21) Appl. No.: 13/829,151

(22) Filed: Mar. 14, 2013

(30) Foreign Application Priority Data
Apr. 13, 2012 (CN) 201220157500.2

(51) Int. Cl. F21V 33/00; F21V 8/00

(52) U.S. Cl. CPC F21V 33/0052; G02B 6/0055
USPC 362/23.04

(57) ABSTRACT

A light guide structure for a phone key includes an LED light source, a light guide film and a light guide element. The light guide element is bended to be a preset shape, one end of the light guide element is disposed in the position coupled to the LED light source; an extended part of same number with the light guide element is extended from the side surface of the light guide film, the extended part of the light guide film is at least fixed to the other end of the corresponding light guide element; a reflection film is disposed in the full or part of the light guide element except the end face of one end of the light guide element and the joint of the light guide element and the extended part to prevent the light entered into the light guide element from shooting out of these surface.

### FIELD OF THE INVENTION

The present invention relates to a mobile phone, especially to a light guide structure for the key of touch phone with high light efficiency.

### BACKGROUND OF THE INVENTION

With the continuous advancement of the communication technology and information technology, the mobile phone has become one of the indispensables in people's daily life. For facilitating to care and use, the mobile phone has been developed to be more miniaturization, lightweight, thin and multi-functional. Thereinto, touch phone is the most popular mobile communication equipment. Although touch phone has a large touch screen, there are still several function keys (ie keys) for user's quick usage. In order to ensure that in the night or weak light conditions, these function keys are still enable to be used, the existing touch phone is disposed with backlight behind the function keys. So when used, the backlight lights and the user can read the character of the function keys. In the exiting touch phone or other mobile phones with keys, backlight is usually achieved by light guide structure. The existing light guide structure usually includes a light guide board (as the light guide structure needs to be made thin, it's called light guide film as well) and an LED light source. The key is disposed above the light guide board, while the LED light source is disposed below the light guide board or in the side of the light guide board. When the phone is used, high strength light will be emitted from the LED light source. With the light guide of the light guide board (refraction and reflection of light), the light comes from the emitting surface of the light guide board to the keys above for the user to read the character of the keys clearly. But in the exiting light guide structure, the light efficiency is low, during the light is emitted from the LED light source to the key through the light guide board, except the light to the character of the keys, other light are light loss. So there is much light loss, which influences the light efficiency. On the other hand, the light is uneven. The display of the character of the keys is uneven in the existing light guide structure.

### SUMMARY OF THE INVENTION

The object of the invention is to overcome the disadvantages of the existing technology and provide with a light guide structure for a mobile phone key, which greatly reduces with the light loss during the light conduction and proves the light efficiency of the LED light source. The light is even from the light guide structure to the character of the keys. In addition, the phone can be made thin for further miniaturization of touch phone.

The technical proposal of the present invention to solve the technical problems is that:

A light guide structure for a phone key includes:

At least an LED light source;

A light guide element of same number with the LED light source, the light guide element is bended to be a preset shape, one end of the light guide element is disposed in the position coupled to the LED light source, the end face of the end is disposed with a certain area to catch the light emitted from the LED light source;

A light guide film, the top surface of which is the light emitting surface, the top surface of the light guide film is disposed in the position coupled to the character of the key; a light diffused structure is disposed on the bottom surface of the light guide film and coupled to the character of the key;

An extended part of same number with the light guide element is extended from the side surface of the light guide film, the extended part of the light guide film is at least fixed to the other end of the corresponding light guide element; in the light guide element, a reflection film is disposed in the full or part of the light guide element except the end face of one end of the light guide element and the joint of the light guide element and the extended part to prevent the light entered into the light guide element from shooting out of these surface.

The light guide element is gradually narrowed from one end to the other end.

The reflector film of the light guide element is electroplating reflector film.

the extended part is a bended thin piece, the bending shape of the thin piece is coupled to the shape of the light guide element; a groove is disposed in the light guide element to couple to the thin piece, the groove is extended from the other end to one end of the light guide element along the surface of the light guide element, the extended part is assembled and fixed in the groove of the light guide element.

The connection of the light guide element and the extended part of the light guide film is gel point connection or supersonic welding connection.

The light diffused structure of the bottom surface of the light guide film is made from frosted with convex points or printed with light guide printing ink points.

a reflection film is disposed on the bottom surface of the light guide film, the reflection film is covered the bottom surface and the outer surface of the diffused structure to prevent the light entry to the light guide film from shooting out of the bottom surface of the light guide film.

A reflection film is disposed on the periphery of the light guide film except the joint of the light guide film and the extended part to prevent light entry to the light guide film from shooting out of the side surface of the light guide film.

A reflection film is disposed on the top surface of the light guide film except the position coupled to the character of the key to prevent light entry to the light guide film from shooting out of the bottom surface.

In the present invention of a light guide structure for a phone key, the light guide element is bended to be a preset shape, which is for the light emitted from the LED light source conduction from one end to the other end of the light guide film. The outer surfaces of the light guide element include two end faces and the outer surface between the two ends. The reflection film is disposed in the outer surface of the light guide element except one end face of the light guide element and the joint of the light guide element and the extended part. The reason is that the end face of one end of the light guide element is disposed to catch the LED light source, so it is disposed without reflection film. The joint of the light guide element and the extended part is disposed to guide the light entry to the light guide element to the extended part, so these areas are disposed without reflection film. The reflection film in other area is disposed to prevent light entry to the light guide element from shooting out of these outer surfaces to course light loss. So the light is totally reflected inside the light guide element for better light entry to the light guide element conduction to the light guide film.

The extended part is disposed to connect to the light guide element, the extended part is shaped to be a bended thin piece to better connect to the light guide element. For totally reflection, a reflection film is disposed on the outer surface of the extended part. The reflection film is disposed on the outer surface of the extended part except the joint of the extended part and the light guide element and the joint of the light guide element and the extended part. The reason is that part of the outer surface of the extended part is connected to the light guide film. The part is disposed without reflection film, making the light of the extended part enable to enter to the light guide film. Another part of outer surface of the extended part is connected to the light guide element. The part is disposed without reflection film either, making the light of the light guide element enable to enter to the extended part. The reflection film is disposed in the rest area, preventing light entry to extended part from shooting out of these outer surfaces to course light loss. So the light is totally reflected inside the extended part for better light entry to the extended part conduction to the light guide film.

The light guide film is disposed to light guide for the character of the key. To improve light efficiency, a reflection film is disposed on some outer surface of the light guide film. The reflection film can be disposed on the bottom surface of the light guide film. The reflection film is disposed on the periphery of the light guide film except the joint of the light guide film and the extended part. The reason is that light of the extended part is guided to the light guide film by the joint of the light guide film and the extended part. so that the part is disposed without reflection film to prevent the light entry to the light guide film from shooting out of the side surface to course light loss. The top surface of the light guide film is light emitting surface, which is light guide from the light guide film to the character of the key. As with the large area of the top surface of the light guide film, most of the light is not guided to the character of the key. The reflection film is disposed on the top surface of the light guide film except the position coupled to the character of the key. The reason is that the position coupled to the character of the key is disposed for light guide to the character of the key, so the part is disposed without refection film except the rest to prevent the light entry to the light guide film from shooting out of the rest of the top surface to course light loss.

When used, the light emitted from the LED light souse is entered from one end (the bigger end) of the light guide element, and then by reflection and totally reflection of the light guide element, to the extended part of the light guide film. By reflection and totally reflection of the extended part of the light guide film, the light is entered into the light guide film. Then by the reflection and totally reflection of the light guide film, the light is shooting to the character of the key from the top surface of the light guide film. The diffused structure on the bottom surface of the light guide film makes light diffused and much even to the character of the key.

The advantages of the present invention are as below: as with the light guide structure made of the LED light source, the light guide film and the light guide element, the top surface of the light guide film is the light emitting surface, which is disposed in the position couplet to the character of the key; a light diffused structure is disposed in the position coupled to the character of the key on the bottom of the light guide film; the light guide element is bended to be a preset shape, and one end of the light guide element is disposed in the position coupled to the character of the key. The end face of one end is disposed with a certain area to catch the light emitted from the LED light source; an extended part of same number with the light guide element is extended from the side surface of the light guide film, the extended part of the light guide film is at least fixed to the other end of the corresponding light guide element; in the light guide element, a reflection film is disposed in the full or part of the light guide element except the end face of one end of the light guide element and the joint of the light guide element and the extended part to prevent the light entered into the light guide element from shooting out of these surface. The present invention greatly reduces with the light loss during the light conduction and proves the light efficiency of the LED light source. The light is even from the light guide structure to the character of the keys. In addition, the phone can be made thin for further miniaturization of touch phone.

As with the reflection film on the outer surface of the extended part except the joint of the extended part and the light guide element and the joint of the extended part and the light guide film, on the bottom surface of the light guide film and the periphery except the joint of the light guide film and the extended part, the top surface of the light guide film except the position coupled to the character of the key, the light efficiency is improved and the light is much more even.

The present invention will be further described with the drawings and embodiment, but it is apparent to those skilled in the art that a variety of modifications and changes may be made without departing from the scope of the present invention.

### BRIEF DESCRIPTION OF THE DRAWINGS

FIG. 1 illustrates the structure of the present invention;

FIG. 2 illustrates the breakdown structure of the present invention;

FIG. 3 illustrates the structure of the light guild film of the present invention;

FIG. 4 illustrates the structure of the bottom surface of the light guide film of the present invention;

FIG. 5 illustrates the structure of the light guide element of the present invention.

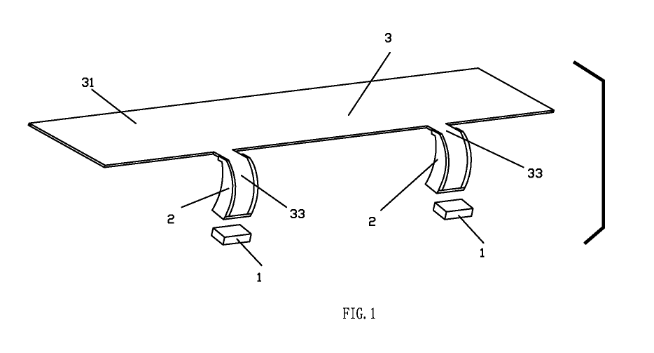

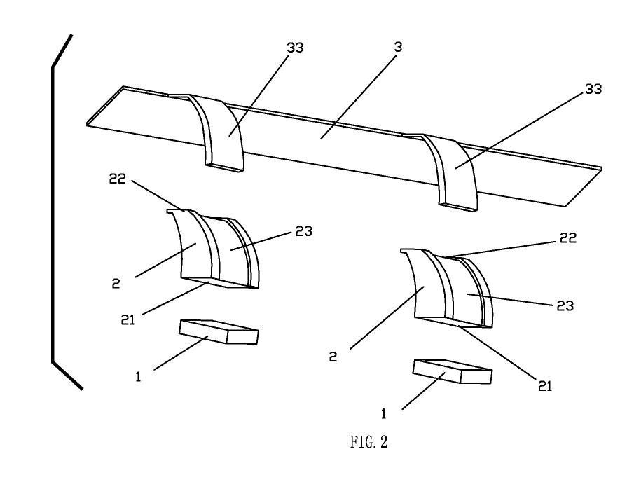

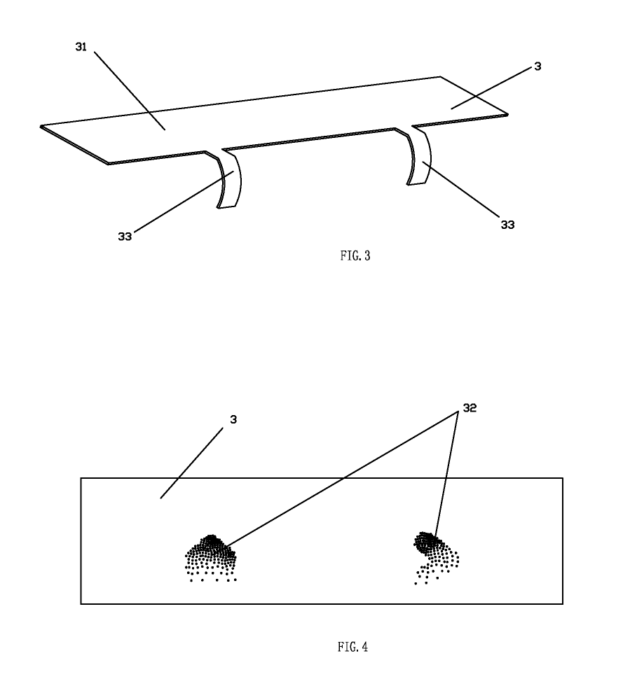

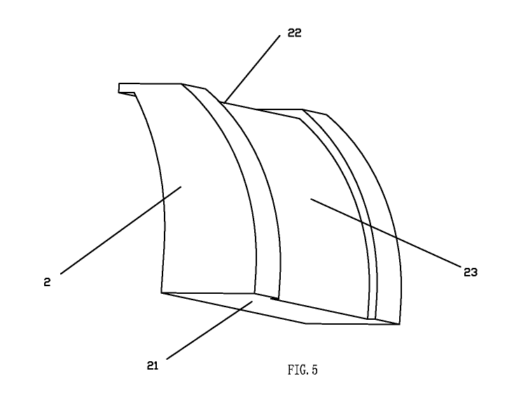

### DETAILED DESCRIPTION OF THE EMBODIMENTS

Refer to the drawings; a light guide structure of the mobile phone key is applied in a touch phone, the touch phone includes a touch module, a bottom housing and an LED drive circuit board, the touch module is connected to the bottom housing, the touch module is disposed with several characters of functional keys (ie. The character of the phone keys). The LED drive circuit board is disposed inside the cavity formed by the touch module and the bottom housing. The light guide structure of the present invention is disposed inside the cavity formed by the touch module and the bottom housing as well.

A light guide structure for a phone key of the present invention includes:

Several LED light source 1 (two LED light sources are provided in the drawings of the embodiment); the number of the LED light source 1 is the same as the functional key of the touch module; the LED light source is disposed on the LED drive circuit board;

A light guide element 2 of same number with the LED light source, the light guide element 2 is bended to be a preset shape, one end 21 of the light guide element is disposed in the position coupled to the LED light source 1, the end face of the end 21 is disposed with a certain area to catch the light emitted from the LED light source 1; the light guide element 2 is gradually narrowed from one end 21 to the other end 22.

A light guide film 3, the top surface 31 of which is set to be the emitting surface, the top surface 31 is disposed in the position coupled to the character of the key; on the bottom surface of the light guide film 3, a light diffused structure 32 is disposed in the position coupled to the character of the key.

A extended part 33 of same number with the light guide element 2 is extended from the side surface of the light guide film 3, the extended part 33 is at least fixed to the other end 22 of the corresponding light guide element; in the light guide element 2, a reflection film is disposed in the full or part of the light guide element except the end face of one end 21 of the light guide element and the joint of the light guide element and the extended part to prevent the light entered into the light guide element 2 from shooting out of these surface. The reflection film of the light guide element 2 of the light guide film is electroplating reflecting film. In the light guide element 2, an electroplating reflection film is disposed in the full or part of the light guide element except the end face of one end 21 of the light guide element and the joint of the light guide element and the extended part. Fully electroplating is better the partial electroplating.

The extended part 33 is a bended thin piece, the bending shape of the thin piece 33 is coupled to the shape of the light guide element 2; a groove 23 is disposed in the light guide element 2 to couple to the thin piece, the groove 23 is extended from the other end 22 (including the end face of the other end) to one end 21 of the light guide element (not including the end face of this end) along the surface of the light guide element 2, the extended part 33 is assembled and fixed in the groove 23 of the light guide element 2. the three surfaces of the extended part 33 are separately connected to the bottom surface and the two side surfaces of the groove 23.

A reflection film is disposed in the surface of the extended part 33 of the light guide film except the joint of the extended part and the light guide element and the joint of the extended part and the light guide film to prevent the light entry to the extended part from shooting out of these surface. The reflection film of the extended part 33 of the light guide film is electroplating reflecting film.

The fixation of the light guide element 2 and the extended part 33 of the light guide film is gel point connection, that is to say, the fixation of the three surfaces of the extended part 33 to the bottom of the groove 23 is gel point connection. the fixation of the light guide element and the extended part of the light guide film can be supersonic welding connection as well.

The light diffused structure 32 of the bottom surface of the light guide film 3 is made by frosted with convex points or printed with light guide printing ink points.

For better light guide efficiency, a reflection film is disposed on the bottom surface of the light guide film 3, the reflection film is covered the bottom surface and the outer surface of the diffused structure to prevent the light entry to the light guide film from shooting out of the bottom surface of the light guide film. The reflection film on the bottom surface of the light guide film 3 is electroplating reflecting film.

For better light guide efficiency, a reflection film is disposed on the periphery of the light guide film 3 except the joint of the light guide film and the extended part to prevent light entry to the light guide film from shooting out of the side surface of the light guide film. The reflection film on the side surface of the light guide film 3 is electroplating reflecting film.

For better light guide efficiency, a reflection film is disposed on the top surface of the light guide film 3 except the position coupled to the character of the key to prevent light entry to the light guide film from shooting out of the bottom surface. The reflection film on the top surface of the light guide film 3 is electroplating reflecting film.

In the present invention of a light guide structure for a phone key, the light guide element 2 is bended to be a preset shape, which is for the light emitted from the LED light source conduction from one end to the other end of the light guide film. The outer surfaces of the light guide element 2 include two end faces and the outer surface between the two ends. The reflection film is disposed in the outer surface of the light guide element except one end face of the light guide element and the joint of the light guide element and the extended part. The reason is that the end face of one end of the light guide element is disposed to catch the LED light source, so it is disposed without reflection film. The joint of the light guide element and the extended part is disposed to guide the light entry to the light guide element to the extended part, so these areas are disposed without reflection film. The reflection film in other area is disposed to prevent light entry to the light guide element from shooting out of these outer surfaces to course light loss. So the light is totally reflected inside the light guide element for better light entry to the light guide element conduction to the light guide film.

The extended part 33 is disposed to connect to the light guide element 2, the extended part is shaped to be a bended thin piece to better connect to the light guide element. For totally reflection, a reflection film is disposed on the outer surface of the extended part. The reflection film is disposed on the outer surface of the extended part 33 except the joint of the extended part and the light guide element and the joint of the light guide element and the extended part. The reason is that part of the outer surface of the extended part is connected to the light guide film. The part is disposed without reflection film, making the light of the extended part enable to enter to the light guide film. Another part of outer surface of the extended part is connected to the light guide element. The part is disposed without reflection film either, making the light of the light guide element enable to enter to the extended part. The reflection film is disposed in the rest area, preventing light entry to extended part from shooting out of these outer surfaces to course light loss. So the light is totally reflected inside the extended part for better light entry to the extended part conduction to the light guide film.

The light guide film 3 is disposed to light guide for the character of the key. To improve light efficiency, a reflection film is disposed on some outer surface of the light guide film. The reflection film can be disposed on the bottom surface of the light guide film. The reflection film is disposed on the periphery of the light guide film except the joint of the light guide film and the extended part. The reason is that light of the extended part is guided to the light guide film by the joint of the light guide film and the extended part. so that the part is disposed without reflection film to prevent the light entry to the light guide film from shooting out of the side surface to course light loss. The top surface of the light guide film is light emitting surface, which is light guide from the light guide film to the character of the key. As with the large area of the top surface of the light guide film, most of the light is not guided to the character of the key. The reflection film is disposed on the top surface of the light guide film except the position coupled to the character of the key. The reason is that the position coupled to the character of the key is disposed for light guide to the character of the key, so the part is disposed without refection film except the rest to prevent the light entry to the light guide film from shooting out of the rest of the top surface to course light loss.

When used, the light emitted from the LED light souse is entered from one end (the bigger end) of the light guide element, and then by reflection and totally reflection of the light guide element, to the extended part of the light guide film. By reflection and totally reflection of the extended part of the light guide film, the light is entered into the light guide film. Then by the reflection and totally reflection of the light guide film, the light is shooting to the character of the key from the top surface of the light guide film. The diffused structure on the bottom surface of the light guide film makes light diffused and much even to the character of the key.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

1. a light guide structure for a phone key, wherein includes:
At least an LED light source;
A light guide element of same number with the LED light source, the light guide element is bended to be a preset shape, one end of the light guide element is disposed in the position coupled to the LED light source, the end face of the end is disposed with a certain area to catch the light emitted from the LED light source;
A light guide film, the top surface of which is the light emitting surface, the top surface of the light guide film is disposed in the position coupled to the character of the key; a light diffused structure is disposed on the bottom surface of the light guide film and coupled to the character of the key;
An extended part of same number with the light guide element is extended from the side surface of the light guide film, the extended part of the light guide film is at least fixed to the other end of the corresponding light guide element; in the light guide element, a reflection film is disposed in the full or part of the light guide element except the end face of one end of the light guide element and the joint of the light guide element and the extended part to prevent the light entered into the light guide element from shooting out of these surface.

2. a light guide structure for a phone key according to the claim 1, wherein the light guide element is gradually narrowed from one end to the other end.

3. a light guide structure for a phone key according to the claim 1, wherein the reflector film of the light guide element is electroplating reflector film.

4. a light guide structure for a phone key according to the claim 1, wherein the extended part is a bended thin piece, the bending shape of the thin piece is coupled to the shape of the light guide element; a groove is disposed in the light guide element to couple to the thin piece, the groove is extended from the other end to one end of the light guide element along the surface of the light guide element, the extended part is assembled and fixed in the groove of the light guide element.

5. a light guide structure for a phone key according to the claim 1, wherein a reflection film is disposed in the surface of the extended part of the light guide film except the joint of the extended part and the light guide element and the joint of the extended part and the light guide film to prevent the light entry to the extended part from shooting out of these surface.

6. a light guide structure for a phone key according to the claim 1, wherein the connection of the light guide element and the extended part of the light guide film is gel point connection or supersonic welding connection.

7. a light guide structure for a phone key according to the claim 1, wherein the light diffused structure of the bottom surface of the light guide film is made by frosted with convex points or printed with light guide printing ink points.

8. a light guide structure for a phone key according to the claim 1, wherein a reflection film is disposed on the bottom surface of the light guide film, the reflection film is covered the bottom surface and the outer surface of the diffused structure to prevent the light entry to the light guide film from shooting out of the bottom surface of the light guide film.

9. a light guide structure for a phone key according to the claim 8, wherein a reflection film is disposed on the periphery of the light guide film except the joint of the light guide film and the extended part to prevent light entry to the light guide film from shooting out of the side surface of the light guide film.

10. a light guide structure for a phone key according to the claim 9, wherein a reflection film is disposed on the top surface of the light guide film except the position coupled to the character of the key to prevent light entry to the light guide film from shooting out of the bottom surface.

11. a light guide structure for a phone key according to the claim 2, wherein a reflection film is disposed in the surface of the extended part of the light guide film except the joint of the extended part and the light guide element and the joint of the extended part and the light guide film to prevent the light entry to the extended part from shooting out of these surface.

12. a light guide structure for a phone key according to the claim 3, wherein a reflection film is disposed in the surface of the extended part of the light guide film except the joint of the extended part and the light guide element and the joint of the extended part and the light guide film to prevent the light entry to the extended part from shooting out of these surface.

13. a light guide structure for a phone key according to the claim 4, wherein a reflection film is disposed in the surface of the extended part of the light guide film except the joint of the extended part and the light guide element and the joint of the extended part and the light guide film to prevent the light entry to the extended part from shooting out of these surface.
